(19) United States
(12) Patent Application Publication
(10) Pub. No.: US 2003/0196838 A1
(43) Pub. Date: Oct. 23, 2003

(54) Scale

(75) Inventors: Klaus Gutzy, Murrhardt (DE); Michael Schurr, Murrhardt (DE); Albrecht Stahl, Murrhardt (DE); Wolfgang Kuhnel, Backnang (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Soehnle-Waagen GmbH & Co. KG, Murrhardt (DE)

(21) Appl. No.: 10/387,941

(22) Filed: Mar. 13, 2003

(30) Foreign Application Priority Data
Mar. 15, 2002 (DE) 102 11 421.8

(51) Int. Cl. G01G 19/00

(52) U.S. Cl. 177/145

(57) ABSTRACT

A scale includes a base plate, a load plate, and at least one weighing cell, wherein the base plate and the load plate extend in planar fashion, and the at least one weighing cell is joined directly by non-positive engagement to the base plate and load plate. The weighing cell may be disposed between the base plate and load plate, and connected to the base plate and load plate by fastening plates which are provided on opposite sides of the weighing cell, or the weighing cell may be disposed above the load plate, and connected to the base plate and load plate by fastening plates which are provided at opposite ends on a same side of the weighing cell. Alternatively, shoulders may be provided on the base plate and load plate, or on the weighing cell, for directly joining the weighing cell to the base plate and load plate.

### FIELD OF THE INVENTION

The invention relates to a scale having a base plate, a load plate, and at least one weighing cell acting between the base plate and load plate.

### BACKGROUND OF THE INVENTION

All scales, including bathroom scales, kitchen scales and industrial scales, as a rule essentially comprise a load plate which is provided on a base plate or base frame with one or more weighing cells interposed between the load plate and the base plate or base frame. The weighing cells are joined together via an evaluation unit, which provides a visible weighing result via a display.

A disadvantage of conventional scales is that the weighing cells are retained on the base plate or base frame or in a housing via fastening elements. This structure substantially determines the height of the scale. In addition, also contributing to the height of the scale are feet for the scale to stand on, which are mounted on the base plate or the base frame.

### OBJECT OF THE INVENTION

The object of the invention is to provide a scale which has a low structural height, and in which the connection of the load plate to the base plate or base frame is simplified so that the scale can be produced from only a few components.

### SUMMARY OF THE INVENTION

To attain the object of the invention, a scale is provided which comprises a base plate, a load plate, and at least one weighing cell, wherein the base plate and the load plate extend in planar fashion, and the at least one weighing cell is joined directly by non-positive engagement to the base plate and load plate. By embodying the base plate and the load plate as plates that extend in planar fashion, with the at least one weighing cell secured directly thereto, the mechanical components can be reduced to a minimum.

The at least one weighing cell may be disposed between the base plate and load plate, and connected to the base plate and load plate by first and second fastening plates, respectively, which are provided on opposite sides of the at least one weighing cell.

Alternatively, the at least one weighing cell may be disposed above the load plate, and connected to the base plate and load plate by first and second fastening plates, respectively, which are provided on a same side of the at least one weighing cell at opposite ends of the at least one weighing cell, with a fastening neck of the first fastening plate connecting the at least one weighing cell to the base plate passes through a bore in the load plate.

Alternatively, the base plate and load plate may each be provided with a shoulder for directly joining the at least one weighing cell to the base plate and load plate, respectively.

Alternatively, the at least one weighing cell may be provided with integrally formed shoulders to which the base plate and the load plate are respectively joined directly.

### BRIEF DESCRIPTION OF THE DRAWINGS

FIG. 1 is a perspective view of a scale according to one embodiment of the present invention with a weighing cell disposed between a base plate and a load plate;

FIG. 2 is an elevation view of a scale according to another embodiment of the present invention with a weighing cell disposed above a load plate;

FIG. 3 is a sectional view taken along the line III-III in FIG. 1;

FIG. 4 is a sectional view taken along the line IV-IV in FIG. 1;

FIG. 5 shows an alternative embodiment in a view corresponding to FIG. 3; and

FIG. 6 shows another alternative embodiment in a view corresponding to FIG. 3.

### DETAILED DESCRIPTION

Several exemplary embodiments of the invention will be described in detail below in conjunction with the drawings.

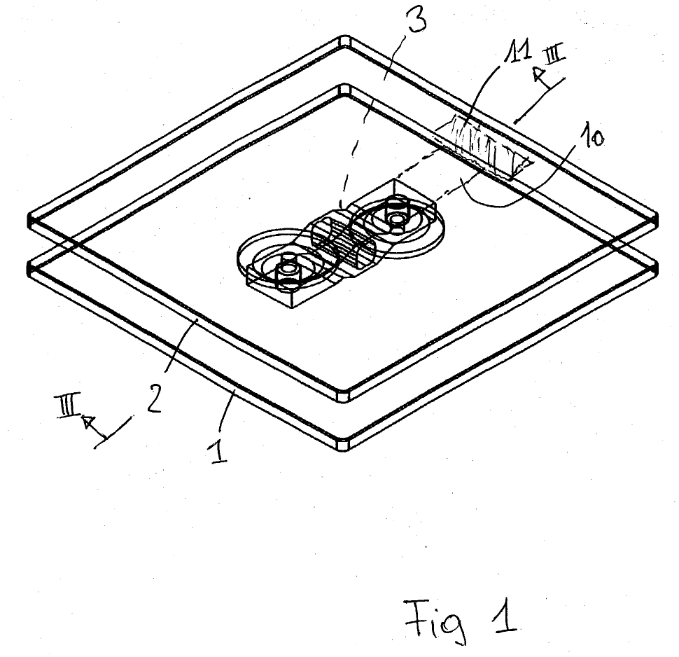

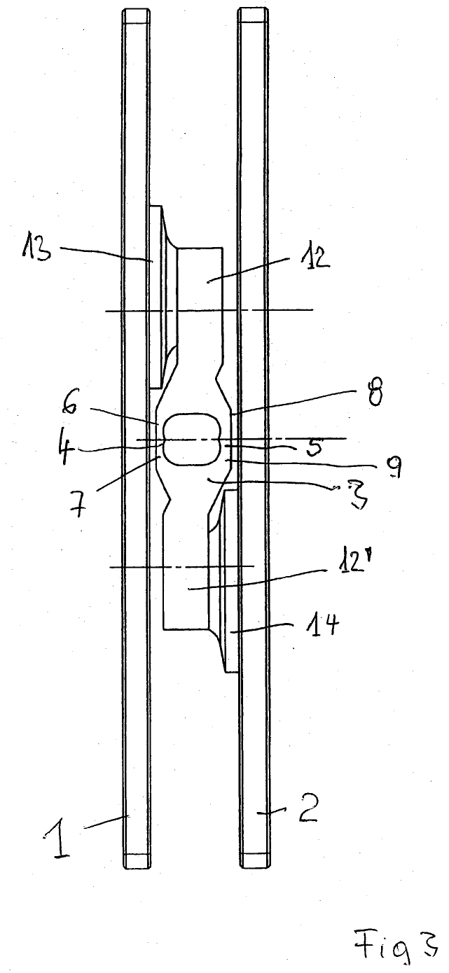

According-to one embodiment of the present invention, as shown in FIG. 1, a weighing cell 3 (or a plurality of weighing cells) are disposed between a base plate 1 and a load plate 2. As shown in FIG. 3, the weighing cell 3 is embodied as a double bending beam weighing cell having a lower steering arm 4 and an upper steering arm 5 which form lower bending points 6, 7 and upper bending points 8, 9. Strain gauges are applied to the bending points and are in communication, via an evaluation unit 10, with a display unit 11. As shown in FIG. 3, the weighing cell 3, behind the bending points 6-9, is provided with respective force introduction means 12, 12′ in a symmetrical manner. A first fastening plate 13 connected to the base plate 1 is mounted on one of the force introduction means 12 on one side of the weighing cell 3, and a second fastening plate 14 connected to the load plate 2 is mounted on the other of the force introduction means 12′ on the other side of the weighing cell 3.

In particular, it is noted that in the embodiment shown in FIGS. 1 and 3, the base plate 1 and load plate 2 are embodied as plates extending in a planar fashion, and the weighing cell 3 (or plurality of weighing cells) is joined directly by non-positive engagement to the base plate 1 and load plate 2 via the first and second fastening plates 13 and 14. And by embodying the base plate 1 and the load plate 2 as plates that extend in planar fashion, with the at least one weighing cell 3 secured directly thereto, the mechanical components can be reduced to a minimum. In addition, by embodying the base plate 1 as a planar plate, an advantage is obtained in that feet for the scale to stand on are no longer needed.

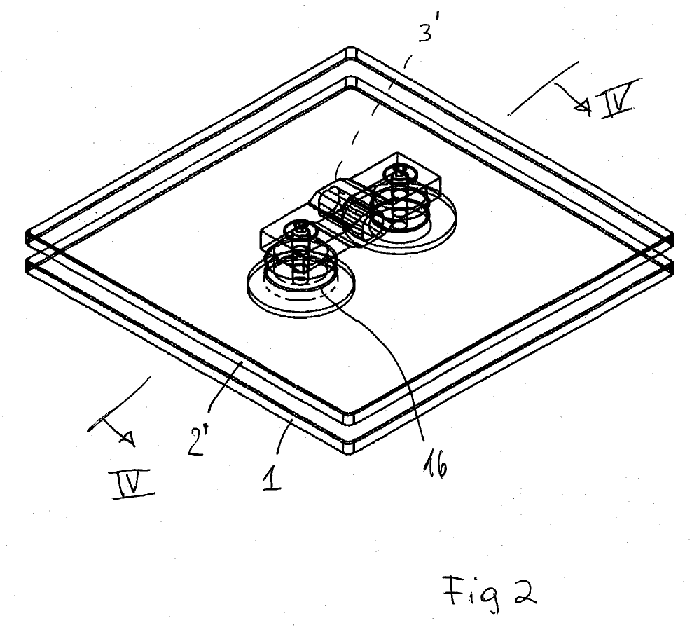

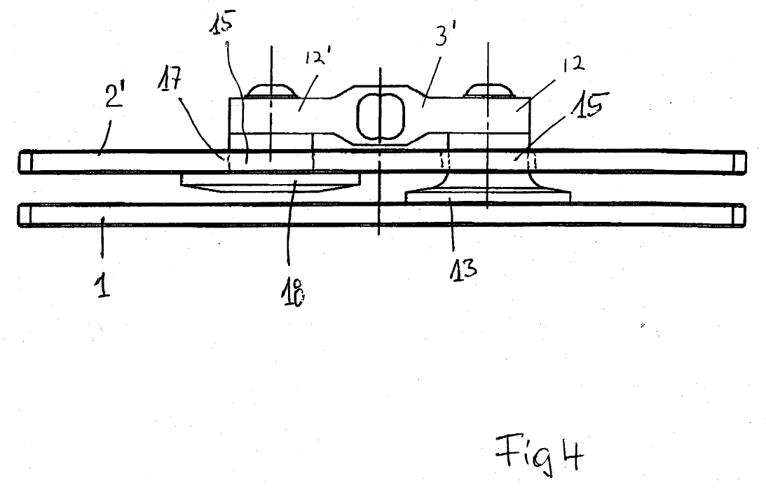

According to another embodiment of the present invention, as shown in FIG. 2, a weighing cell 3′, which is essentially equivalent in structure to the weighing cell 3 shown in FIG. 3, is disposed above a load plate 2′. In this embodiment, as shown in FIG. 4, the first fastening plate 13 is connected to one of the force introduction means 12 of the weighing cell 3′ on the base plate 1, via a fastening neck 15 that penetrates the load plate 2′ through a bore in the load plate 2′. Another fastening neck 15 is passed through the load plate 2′ via a bore 17 at the other force introduction means 12′ of the weighing cell 3′, and the load plate 2′ is placed on a second fastening plate 18. In this structure, the base plate 1 and load plate 2′ are connected to the same side of the weighing cell 3′.

In particular, it is noted that in the embodiment shown in FIGS. 2 and 4, an especially shallow construction is attained by disposing the weighing cell 3′ above the load plate 2′.

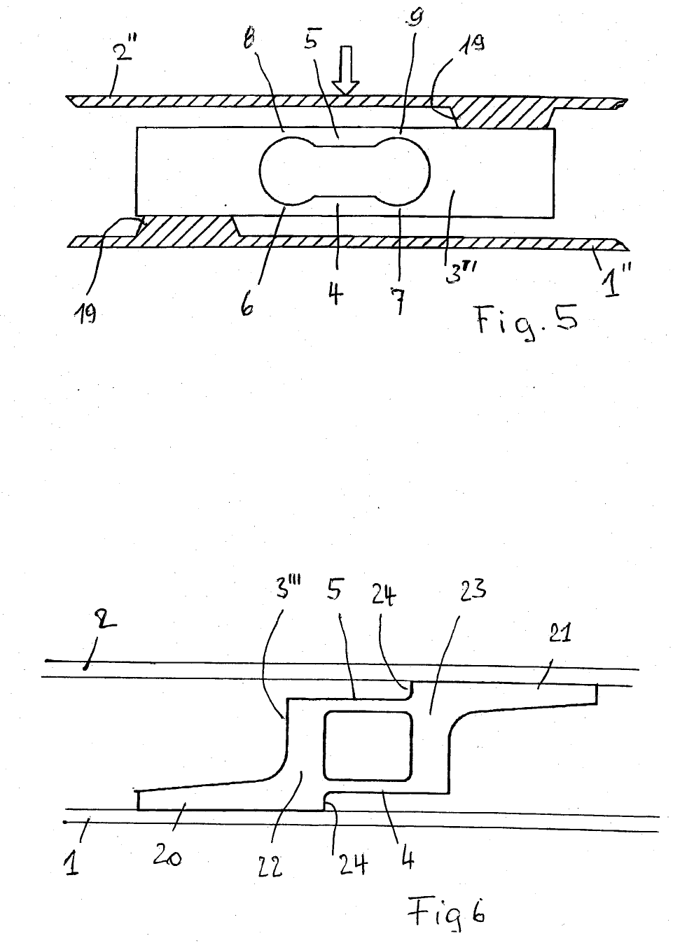

According to an alternative embodiment shown in FIG. 5, a weighing cell 3″ is directly joined to a base plate 1″ and a load plate 2″. To accomplish this, a shoulder 19 is provided on both the base plate 1″ and the load plate 2″. The shoulders 19, in their simplest form, can be embodied as shims, but if the load plate 1 and base plate 2 are formed from sheet-metal parts the shoulders 19 can be formed by deformation. Alternatively, if the base plate 1 and load plate 2 are embodied as glass plates, the shoulders 19 can be formed directly thereon. By profiling the load plate 1″ and the base plate 2″ to achieve fastening, the scale can be produced from a reduced number of parts and the structure of the weighing cell 3″ can be kept simple.

According to another alternative embodiment shown in FIG. 6, a weighing cell 3′″ is provided in which a lower receiving arm 20 and an upper receiving arm 21 are formed at corners 22 and 23 of the weighing cell 3′″ to thereby form shoulders 24 to which the load plate 2 and the base plate 1 can be respectively secured directly. By embodying the fastening mechanism integrally with the weighing cell 3′″, the scale can be produced from a reduced number of parts and the structure of the scale can be made simple.

In each of the above described structures, both the load plate and the base plate can be made from various materials, including, for example, profiled stamped sheet-metal parts, wood materials, stone, and glass.

It is also noted that various weighing cells may be utilized such as so-called center point weighing cells, plane weighing cells, bending rod weighing cells, bending beam weighing cells, and platform weighing cells. In this connection, it is noted that by using only one bending beam weighing cell as a so-called center point weighing cell, for example, the construction of the scale is simplified.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

We claim:

1. A scale comprising:
base plate,
a load plate, and
at least one weighing cell,
wherein the base plate and the load plate extend in planar fashion, and the at least one weighing cell is joined directly by non-positive engagement to the base plate and load plate.

2. The scale of claim 1, wherein the at least one weighing cell is disposed between the base plate and load plate, and is connected to the base plate and load plate by first and second fastening plates, respectively, which are provided on opposite sides of the at least one weighing cell.

3. The scale of claim 1, wherein the at least one weighing cell is disposed above the load plate, and is connected to the base plate and load plate by first and second fastening plates, respectively, which are provided on a same side of the at least one weighing cell at opposite ends of the at least one weighing cell, and wherein a fastening neck of the first fastening plate connecting the at least one weighing cell to the base plate passes through a bore in the load plate.

4. The scale of claim 1, wherein the base plate and load plate are each provided with a shoulder for directly joining the at least one weighing cell to the base plate and load plate, respectively.

5. The scale of claim 1, wherein the at least one weighing cell is provided with integrally formed shoulders to which the base plate and the load plate are respectively joined directly.

6. The scale of claim 5, wherein the shoulder are provided in stepped form.

7. The scale of claim 1, wherein the at least one weighing cell comprises a bending beam weighing cell.

8. The scale of claim 1, wherein the at least one weighing cell comprises a double bending beam weighing cell.
